(19) United States
(12) Patent Application Publication
(10) Pub. No.: US 2010/0079378 A1
(43) Pub. Date: Apr. 1, 2010

(54) LIGHT EMITTING KEYBOARD MODULE AND POWER SAVING METHOD THEREOF

(75) Inventor: Chang-Chia Chiang, Taipei County (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: DARFON ELECTRONICS CORP., Taoyuan (TW)

(21) Appl. No.: 12/560,555

(22) Filed: Sep. 16, 2009

(30) Foreign Application Priority Data
Sep. 26, 2008 (TW) 97137257

(51) Int. Cl. G06F 3/02

(52) U.S. Cl. 345/168

(57) ABSTRACT

A light emitting keyboard module including a light emitting keyboard and a control transmitting module is provided. The control transmitting module includes a transmitting unit, a timing unit, a comparing unit and a processing unit. The transmitting unit communicates with the light emitting keyboard by signals. The timing unit counts a stop time of the light emitting keyboard. The comparing unit compares the stop time with a predetermined time, and generates a comparing signal when the stop time is greater than the predetermined time. The processing unit drives the light emitting keyboard to enter a power saving mode after receiving the comparing signal.

This application claims the benefit of Taiwan application Serial No. 97137257, filed Sep. 26, 2008, the subject matter of which is incorporated herein by reference.

### BACKGROUND OF THE INVENTION

1. Field of the Invention

The invention relates in general to a keyboard module, and more particularly to a light emitting keyboard module and a power saving method thereof.

2. Description of the Related Art

As the concept of reducing carbon dioxide emissions is widely advocated, how to reduce the consumption of energy or power in the household as well as in the office has become the focus of concern for many people.

When a user operates the keyboard, if the ambient light is too dim and the user cannot recognize the keys of the keyboard, other illumination device must be used for the user to operate the keyboard normally. Under such circumstance, extra power is consumed.

Currently, relevant products using light emitting keyboard are available in the market. The key feature is that the keyboard emits light and the user can use the keyboard even when the ambient light is not strong. Such light emitting keyboard which enables the user's operation when the ambient light is dim is indeed conformed to the concept of energy saving.

### SUMMARY OF THE INVENTION

The invention is directed to a light emitting keyboard module and a power saving method thereof. Whether the light emitting keyboard is driven to enter a power saving mode is determined according to the state of an input device such as a mouse or a touch panel. Thus, the power consumption of the light emitting keyboard is reduced to a minimum, and the light emitting keyboard is more environmental friendly.

According to a first aspect of the present invention, a light emitting keyboard module including a light emitting keyboard and a control transmitting module is provided. The control transmitting module includes a transmitting unit, a timing unit, a comparing unit and a processing unit. The transmitting unit communicates with the light emitting keyboard by signals. The timing unit counts a stop time of the light emitting keyboard. The comparing unit compares the stop time with a predetermined time, and generates a comparing signal when the stop time is greater than the predetermined time. The processing unit drives the light emitting keyboard to enter a power saving mode after receiving the comparing signal.

According to a second aspect of the present invention, a power saving method of a light emitting keyboard is provided. The method includes the following steps. Firstly, the states of a light emitting keyboard and an input device are detected. Next, a stop time of the light emitting keyboard is counted before the light emitting keyboard outputs signals. Then, the stop time is compared with a predetermined time, and the light emitting keyboard is driven to enter a power saving mode according to the state of the input device when the stop time is greater than the predetermined time.

According to a third aspect of the present invention, a light emitting keyboard module including a light emitting keyboard and a processing unit is provided. The light emitting keyboard is coupled to a computer. The processing unit is used for determining whether a screen saver of the computer is activated: if yes, driving the light emitting keyboard to enter a power saving mode.

The invention will become apparent from the following detailed description of the preferred but non-limiting embodiments. The following description is made with reference to the accompanying drawings.

### BRIEF DESCRIPTION OF THE DRAWINGS

FIG. 1 shows a circuit diagram of a light emitting keyboard module being connected to a computer and an input device according to a preferred embodiment of the invention;

FIG. 2 shows a physical diagram of the light emitting keyboard, the computer and the input device of FIG. 1;

FIG. 3 shows a flowchart of a power saving method of a light emitting keyboard according to a preferred embodiment of the invention;

FIG. 4 shows the detailed procedure of the step of FIG. 3 of driving the light emitting keyboard to enter a power saving mode according to the state of the input device;

FIG. 5 shows another flowchart of a power saving method of a light emitting keyboard according to a preferred embodiment of the invention; and

FIG. 6 shows a flowchart of the power saving method further including the step of detecting the state of the computer.

### DETAILED DESCRIPTION OF THE INVENTION

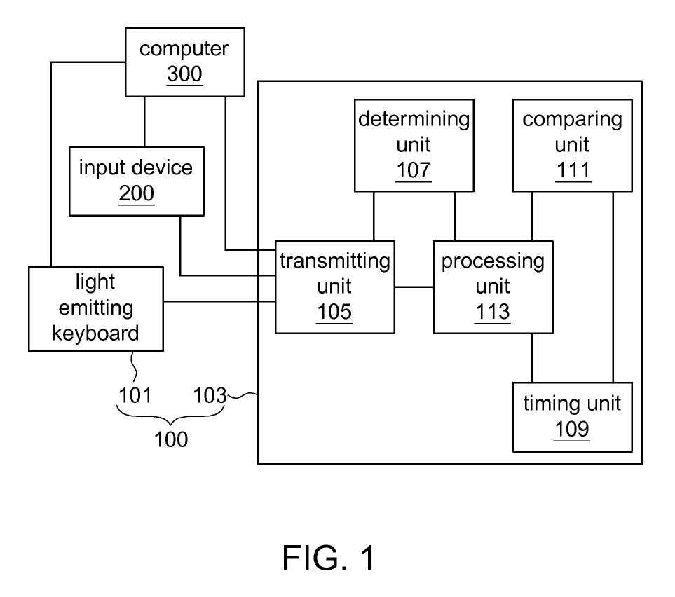

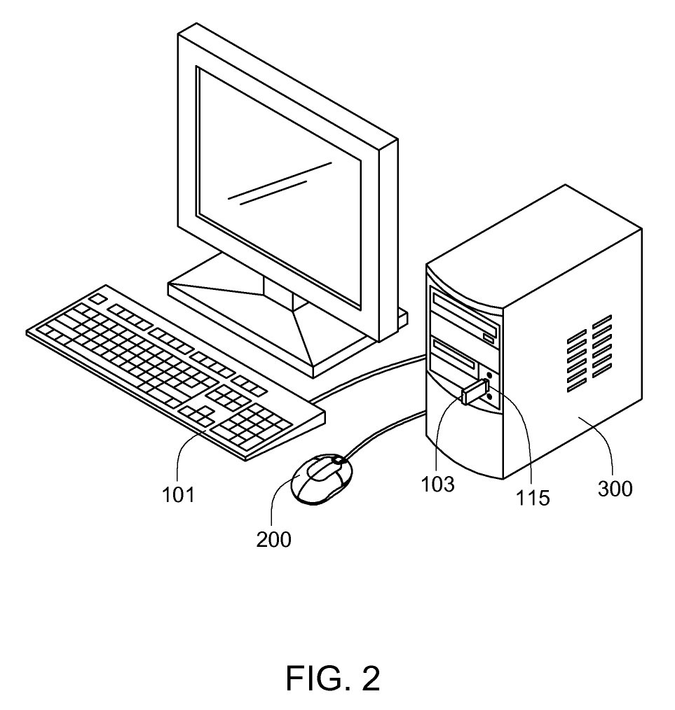

FIG. 1 shows a circuit diagram of a light emitting keyboard module being connected to a computer and an input device according to a preferred embodiment of the invention. FIG. 2 shows a physical diagram of the light emitting keyboard, the computer and the input device of FIG. 1. As indicated in FIG. 1, the light emitting keyboard module 100 includes a light emitting keyboard 101 and a control transmitting module 103. The control transmitting module 103 includes a transmitting unit 105, a determining unit 107, a timing unit 109, a comparing unit 111 and a processing unit 113. The transmitting unit 105 communicates with the light emitting keyboard 101, an input device 200 and a computer 300 by signals. The computer 300 of the present embodiment of the invention is a desktop computer for example.

The input device 200 is a touch panel or a mouse for example. As indicated in FIG. 2, the input device 200 is exemplified by a mouse in the present embodiment of the invention. The control transmitting module 103 of the present embodiment of the invention is disposed in a wireless receiver 115 which is connected to the computer 300. Preferably, the light emitting keyboard 101 has a wireless transmitter (not illustrated) for transmitting the generated signals to the wireless receiver 115. However, the control transmitting module 103 of the present embodiment of the invention can also be directly disposed in the computer 300 for communicating with the application programs of the computer 300.

The determining unit 107 determines whether the transmitting unit 105 receives signals from the light emitting keyboard 101 and the input device 200. The timing unit 109 respectively counts the stop time of the light emitting keyboard 101 and the stop time of the input device 200 when the determining unit 107 determines that the transmitting unit 105 does not receive signals from the light emitting keyboard 101 and the input device 200. The comparing unit 111 compares the stop time with a predetermined time, and generates a comparing signal when the stop time is greater than the predetermined time. The processing unit 113 determines whether to drive the light emitting keyboard 101 to enter a power saving mode according to the state of the input device 200 after receiving the comparing signal. Also, the processing unit 113 can determine whether to drive the light emitting keyboard 101 to enter a power saving mode according to the state of according to the computer 300.

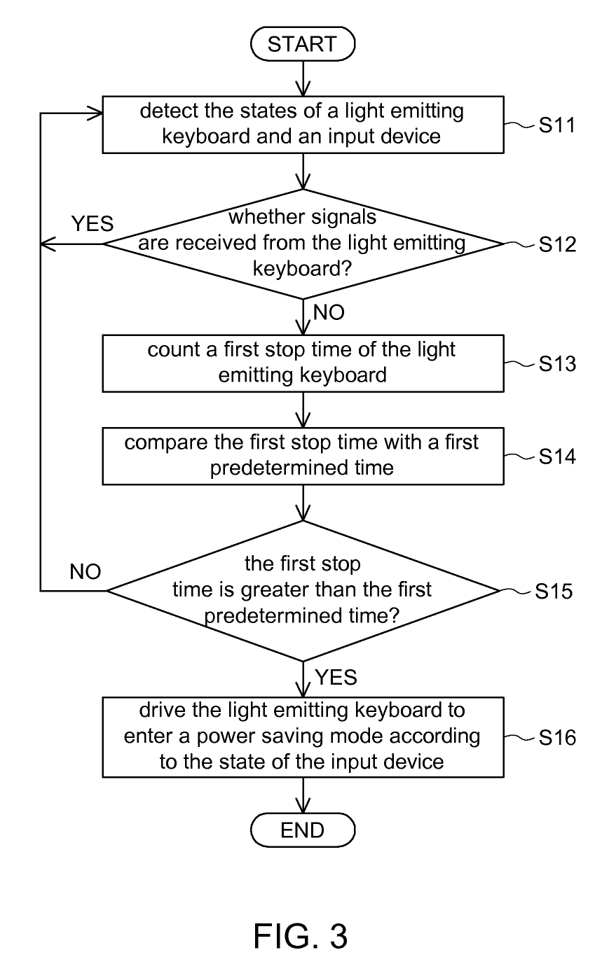

Referring to FIG. 3, a flowchart of a power saving method of a light emitting keyboard according to a preferred embodiment of the invention is shown. The power saving method of the light emitting keyboard includes steps S11˜S16, and each step is exemplified by the light emitting keyboard module 100 of FIG. 1.

Firstly, the method begins at step S11 that the states of the light emitting keyboard 101 and the input device 200 are detected. In the present step, the states of the light emitting keyboard 101 and the input device 200 are determined by detecting whether the light emitting keyboard 101 and the input device 200 transmit signals. The determining unit 107 determines whether the transmitting unit 105 receives signals from the light emitting keyboard 101 and the input device 200.

Next, the method proceeds to step S12, whether signals are received from the light emitting keyboard 101 is determined. If signals keep being received from the light emitting keyboard 101, then method returns to step S11. If no signal is received from the light emitting keyboard 101, then the method proceeds to step S13. That is, when the determining unit 107 determines that the transmitting unit 105 does not receive signals from the light emitting keyboard 101, the method proceeds to step S13 that the timing unit 109 begins to count a first stop time of the light emitting keyboard 101.

Then, the method proceeds to step S14, the first stop time is compared with a first predetermined time. The first predetermined time is a period of time within which the light emitting keyboard 101 is allowed to remain untouched. If the stop time is greater than the above period of time, this implies that the light emitting keyboard 101 has been left idle by the user over a period of time, and it is suggested that the light emitting keyboard 101 be driven to enter a power saving mode. For example, most of the light emitting keyboards have backlight illumination function, so the backlight function of the light emitting keyboard 101 can be turned off under the power saving mode.

In step S15, the comparing unit 111 determines whether the first stop time of the light emitting keyboard 101 is greater than the first predetermined time. If the comparing unit 111 determines that the first stop time of the light emitting keyboard 101 is smaller than the first predetermined time, then the method returns to step S11. If the comparing unit 111 determines that the first stop time of the light emitting keyboard 101 is greater than the first predetermined time, then the method proceeds to step S16.

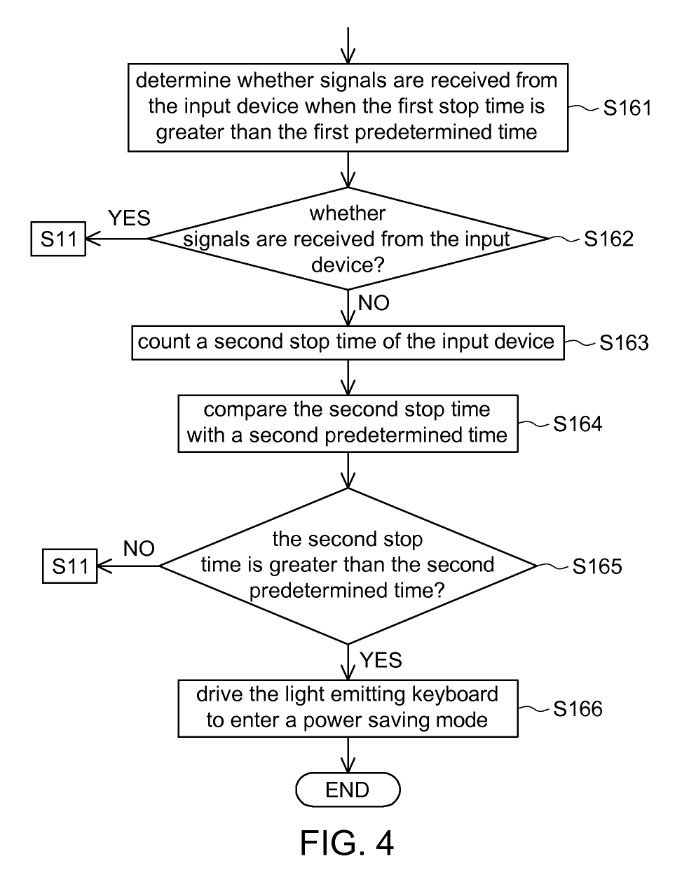

In step S16, the light emitting keyboard 101 is driven to enter a power saving mode according to the state of the input device 200. The detailed procedure of the present step is disclosed in FIG. 4. As indicated in FIG. 4, step S16 includes steps S161˜S166.

As indicated in step S161, whether signals are received from the input device 200 is determined when the first stop time is greater than the first predetermined time. As indicated in step S162, the determining unit 107 determines whether the transmitting unit 105 still receives signals from the input device 200 after the first stop time. If the transmitting unit 105 still receives signals from the input device 200 after the first stop time, the method returns to step S11 (referring to FIG. 3), the states of the light emitting keyboard 101 and the input device 200 are detected. That the transmitting unit 105 still receives signals from the input device 200 after the first stop time implies that the user still uses the input device 200 and the computer 300 for communication despite the light emitting keyboard 101 has not been used for a period of time, and there is no need to turn off the light emitting keyboard 101.

In step S162, whether signals are received from the input device 200 is determined. If no signal from the input device 200 is detected, then the method proceeds to step S163, the timing unit 109 starts to count a second stop time of the input device 200.

Next, the method proceeds to step S164, the second stop time is compared with a second predetermined time. Similarly, the second predetermined time is an estimated period of time that the user does not use the input device 200. Let the mouse be taken for example. When browsing webpage or editing documents, the user normally operates the computer by clicking or dragging with a mouse. If the mouse does not generate any signal within a period of time, this implies that the user is no more in front of the computer or has finished using the computer, and it is suggested that the light emitting keyboard 101 be driven to enter a power saving mode.

As indicated in step S165, whether the second stop time is greater than the second predetermined time is determined. If the second stop time is smaller than the second predetermined time, then the method returns to step S11 (referring to FIG. 3), the states of the light emitting keyboard 101 and the input device 200 keep being detected; if the second stop time is greater than the second predetermined time, then the method proceeds to step S166, the light emitting keyboard 101 is driven to enter a power saving mode.

In the above embodiment, the signal generated by the light emitting keyboard 101 is detected first, and if the light emitting keyboard 101 does not generate signals for a period of time, whether to drive the light emitting keyboard 101 to enter a power saving mode is determined according to the state of the input device 200 (such as the mouse or the touch panel). However, the light emitting keyboard module 100 of the present embodiment of the invention can detect the light emitting keyboard 101 and the state of the input device 200 at the same time so as to determine whether to drive the light emitting keyboard 101 to enter a power saving mode.

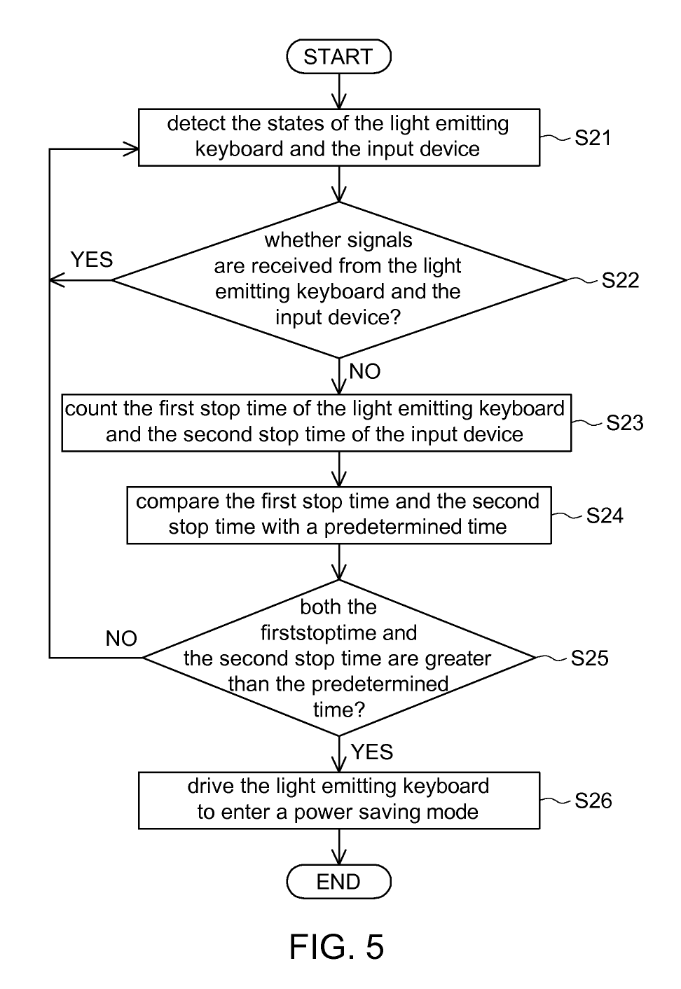

Referring to FIG. 5, another flowchart of a power saving method of a light emitting keyboard according to a preferred embodiment of the invention is shown. As indicated in step S21, the states of the light emitting keyboard 101 and the input device 200 are detected. Then, the method proceeds to step S22, whether signals are received from the light emitting keyboard 101 and the input device 200 is determined. According to the method flowchart of FIG. 5, the method proceeds to step S23 only when no signal is received from the light emitting keyboard 101 or the input device 200 during the period of detection. In step S23, the first stop time of the light emitting keyboard 101 is counted, and the second stop time of the input device 200 is counted. Next, the method proceeds to step S24, the first stop time and the second stop time are compared with a predetermined time, wherein the predetermined time is a period of time allowing no signal is outputted from the light emitting keyboard 101 and the input device 200.

Then, the method proceeds to step S25, whether both the first stop time and the second stop time are greater than the predetermined time is determined. If no, then the method returns to step S21. To the contrary, if both are greater than the predetermined time, then the method proceeds to step S26, the light emitting keyboard 101 is driven to enter a power saving mode. That the first stop time and the second stop time are greater than the predetermined time implies that the user has left the light emitting keyboard 101 and the input device 200 over a period of time.

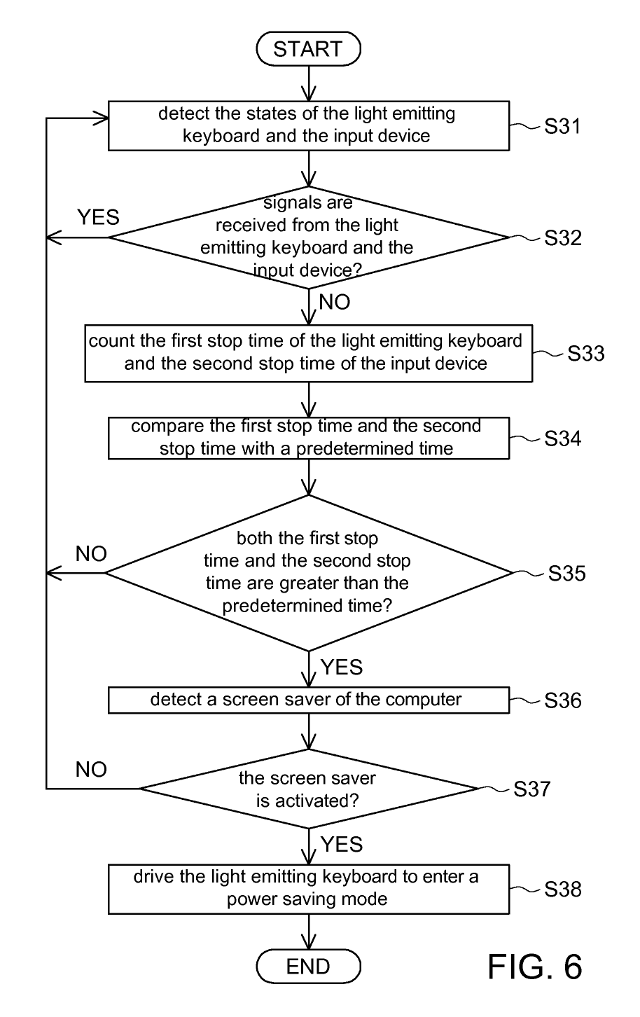

As the light emitting keyboard module 100 and the computer 300 are connected, whether the light emitting keyboard 101 is driven to enter a power saving mode can be determined according to the state of the computer 300, and the procedures are illustrated in FIG. 6. Steps S31˜S35 of FIG. 6 are similar to steps S21˜S25 of FIG. 5, and are not repeated here. In step S35, after detecting that the first stop time and the second stop time of the light emitting keyboard 101 and the input device 200 are greater than the predetermined time, the method proceeds to step S36 that the screen saver of the computer 300 is detected.

As shown in step S37, if the screen saver of the computer 300 is detected to be activated, then the method proceeds to step S38, the light emitting keyboard 101 is driven to enter a power saving mode, otherwise the method returns to step S31. That the screen saver of the computer 300 is detected to be activated implies that the user does not use the computer 300 temporarily or has not used it over a period of time. The way of determining whether to drive the light emitting keyboard 101 to enter a power saving mode according to whether the screen saver is detected can be applied to the procedure of FIG. 4. That is, after both the light emitting keyboard 101 and the input device 200 are detected to have been left idle over a period of time, then the state of the computer 300 is detected so as to determine whether to activate the power saving mode.

According to the light emitting keyboard module and the power saving method thereof disclosed in the above embodiments of the invention, whether to drive the light emitting keyboard to enter a power saving mode is determined according to the states of the light emitting keyboard and the input device (such as the mouse or the touch panel). After the light emitting keyboard has been left idle over a period of time, if the input device is also idle, then it is suggested that the light emitting keyboard be driven to enter a power saving mode. Besides, the light emitting keyboard module can also drive the light emitting keyboard to enter a power saving mode according to the state of the computer to which the light emitting keyboard module is connected, such as the state of the screen saver of the computer. Under the power saving mode, the backlight function of the light emitting keyboard is turned off, so that the light emitting keyboard stops emitting the light when not in use, or the power supply of the light emitting keyboard is cut off, largely reducing the power consumption of the light emitting keyboard. The light emitting keyboard module and the power saving method thereof when used in the desktop computer are really capable of reducing carbon dioxide emissions.

Despite the above embodiments are exemplified by desktop computer, the light emitting keyboard module and the power saving method thereof disclosed in the above embodiments of the invention can also be used in electronic devices especially in various hand-held electronic devices such as notebook computer, mobile phone, personal digital assistant (PDA), translation machine, game boy, and so on. As the light emitting keyboard is timely driven to enter a power saving mode to reduce power consumption, the light emitting keyboard does not consume too much power of these hand-held electronic devices. Therefore, the hand-held electronic devices do not need to be re-charged or replace battery frequently, hence greatly increasing the utility efficiency of these hand-held electronic devices.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A light emitting keyboard module, comprising:
a light emitting keyboard; and
a control transmitting module, comprising:
a transmitting unit used for communicating with the light emitting keyboard by signals;
a timing unit used for counting a first stop time of the light emitting keyboard;
a comparing unit used for comparing the first stop time with a first predetermined time and for generating a first comparing signal when the first stop time is greater than the first predetermined time; and
a processing unit used for driving the light emitting keyboard to enter a power saving mode after receiving the first comparing signal.

2. The light emitting keyboard module according to claim 1, wherein
the timing unit further counts a second stop time of an input device;
the comparing unit further compares the second stop time with a second predetermined time, and generates a second comparing signal when the second stop time is greater than the second predetermined time; and
the processing unit further drives the light emitting keyboard to enter the power saving mode after receiving the second comparing signal.

3. The light emitting keyboard module according to claim 2, wherein the input device is a mouse or a touch panel.

4. The light emitting keyboard module according to claim 1, wherein when the determining unit determines that the transmitting unit does not receive signals from the light emitting keyboard and an input device:
the timing unit further counts a second stop time of the input device in addition to counting the first stop time of the light emitting keyboard;
the comparing unit further compares the second stop time with the first predetermined time in addition to comparing the first stop time to the first predetermined time, and generates the first comparing signal when the second stop time is also greater than the first predetermined time; and
the processing unit drives the light emitting keyboard to enter the power saving mode after receiving the first comparing signal.

5. The light emitting keyboard module according to claim 1, wherein the processing unit further communicates with a computer by signals, and drives the light emitting keyboard to enter the power saving mode when the processing unit receives the signal indicating that a screen saver of the computer is activated.

6. The light emitting keyboard module according to claim 1, further comprising:
a wireless receiver connected to a computer, wherein the control transmitting module is disposed in the wireless receiver.

7. The light emitting keyboard module according to claim 1, wherein the light emitting keyboard has a wireless transmitter.

8. The light emitting keyboard module according to claim 1, wherein the control transmitting module is disposed in a computer.

9. A power saving method of a light emitting keyboard, wherein the method comprises:
a. detecting the states of a light emitting keyboard and an input device;
b. counting a first stop time of the light emitting keyboard before the light emitting keyboard outputs signals; and
c. comparing the first stop time with a first predetermined time, and further driving the light emitting keyboard to enter a power saving mode according to the state of the input device when the first stop time is greater than the first predetermined time.

10. The power saving method according to claim 9, wherein the step c comprises:
determining whether signals are received from the input device when the first stop time is greater than the first predetermined time;
counting a second stop time of the input device before the input device outputs signals; and
comparing the second stop time with a second predetermined time, and driving the light emitting keyboard to enter the power saving mode when the second stop time is greater than the second predetermined time.

11. The power saving method according to claim 9, wherein the step b further comprises counting a second stop time of the input device when the input device does not output signals either, and the step c further comprises:
comparing the first stop time with the first predetermined time, comparing the second stop time with the first predetermined time, and driving the light emitting keyboard to enter the power saving mode when the first stop time and the second stop time are both greater than the first predetermined time.

12. The power saving method according to claim 9, wherein the light emitting keyboard and the input device are connected to a computer, the step b comprises counting a second stop time of the input device when the input device does not output signals either, and the step c further comprises:
comparing the first stop time with the first predetermined time, comparing the second stop time with the first predetermined time, and detecting the state of the computer when the first stop time and the second stop time are both greater than the first predetermined time; and
determining whether a screen saver of the computer is activated: if yes, driving the light emitting keyboard to enter the power saving mode.

13. A light emitting keyboard module, comprising:
a light emitting keyboard coupled to a computer; and
a processing unit used for determining whether a screen saver of the computer is activated: if yes, driving the light emitting keyboard to enter a power saving mode.
